(19) United States
(12) Patent Application Publication
(10) Pub. No.: US 2016/0227812 A1
(43) Pub. Date: Aug. 11, 2016

(54) Method for Producing Chocolate Products in the Form of a Flower

(71) Applicant: PRALIBEL NV, Vichte (BE)

(72) Inventor: Paul Sulmon, Deerlijk (BE)

(73) Assignee: Pralibel NV, Vichte (BE)

(21) Appl. No.: 14/914,009

(22) PCT Filed: Oct. 2, 2014
(86) PCT No.: PCT/IB2014/065013

§ 371 Date: Feb. 24, 2016

(30) Foreign Application Priority Data
Oct. 9, 2013 (BE) BE-2013/0674

(51) Int. Cl. A23G 1/54; A23G 1/00

(52) U.S. Cl. CPC A23G 1/545; A23G 1/0059; A23G 1/0076

(57) ABSTRACT

The present invention relates to a method for forming a chocolate product (1), wherein the method comprises the following steps: the supply of a sheet (2) of edible material; the punching of a part (3) from the supplied sheet of edible material; the placement of the punched-out part (3) in a chocolate holder (5), and the application of one or more fillings to the punched-out part (3) provided in the chocolate holder (5).

The present invention relates to a method for producing chocolate products, in particular the present invention relates to a method for producing chocolate products in the form of a flower. The formed chocolate products are preferably pralines.

Pralines, also referred to as chocolates, are generally known and consist of a filling, coated with a thin layer of chocolate. The production of the pralines can be realized by dipping the filling into melted chocolate. This can be performed both manually and automatically.

Pralines can also be produced in moulds. Into these moulds is first poured a thin layer of melted chocolate, which sticks to the wall of the mould. Following setting (hardening of the melted chocolate), the formed chocolate envelope is filled with a filling and subsequently covered over with likewise a thin layer of chocolate.

The pralines which are thus formed are subsequently packed. This can be done in a variety of ways. The most common way of packing is that in which a number of pralines are packed in a (decorated or undecorated) box. Pralines can also however be packed differently, such as, for example, in a dish or shell made of chocolate.

The object of the present invention consists in providing a new method for producing a new range of chocolate products.

The object of the invention is achieved by providing a method for forming a chocolate product, wherein the method comprises the following steps:
the supply of a sheet of edible material;
the punching of a part from the supplied sheet of edible material;
the placement of the punched-out part in a chocolate holder;
the application of one or more fillings to the punched-out part provided in the chocolate holder.

By aiming to produce a chocolate product in this way, a totally new range of chocolate products can begin to be produced. It becomes possible, as it were, to add a new dimension to the production of pralines, especially elements relating to nature (flowers or other elements from nature).

In a preferred embodiment of the method according to the invention, the punched-out part provided with the filling is folded such that at least a part of the applied filling remains visible. In this way, the product becomes more visually appealing to the consumer, who can at the same time see a part of the filling.

In an alternative embodiment of the method according to the invention, the punched-out part provided with the filling is folded up. In this case, as a result of the folding-up of the punched-out part provided with a filling, the side edge (s) of the punched-out shape butt virtually one against another.

According to a preferred method in accordance with the invention, a covering layer is applied to the one or more fillings. It is evident that, where appropriate, the covering layer will remain visible after the partial folding of the punched-out part.

In a particular method in accordance with the invention, the filling or the covering layer is provided with a decoration layer and/or decoration element. Possible decoration layers and/or decoration elements are: chocolate products, sugar products, nuts, spices, edible plants or flowers, print designs (such as, for example, images, letters, logos) applied with edible ink, fruits or fruit products. The applied decoration layer and/or decoration elements can also be a mixture of different ingredients which, after mixing or preparation, are applied to the covering layer or filling.

The applied filling is preferably a mixture of different ingredients which are standardly used in the baking, patisserie and chocolate sector. In a more particular method according to the invention, the applied filling is chosen from one or more of the following products: butter creams, liquid creams, praliné, ganaches, marzipan products, fruit fillings, caramel-based filling, truffle mixtures, and/or yoghurt fillings.

In order to begin to imitate the stems of a flower, in a more preferred method in accordance with the invention incisions are made in at least a part of the outer edge of the punched-out part. The incisions can be very diverse; incisions which (visually) open out into flowers having three leaves to incisions which (visually) open out into flowers having more than six leaves. The incisions can be of both angular and rounded design.

In accordance with a particularly advantageous method according to the invention, the formed chocolate product weighs between 5 and 50 gr.

In order to further illustrate the characteristics of the present invention and indicate additional advantages and peculiarities thereof, there now follows a more detailed description of the method for forming chocolate products according to the invention. Let it be clear that nothing in the following description can be interpreted as a limitation of the protection, claimed in the claims, for the present invention.

In this description, reference is made by means of reference numerals to the appended drawings, wherein:

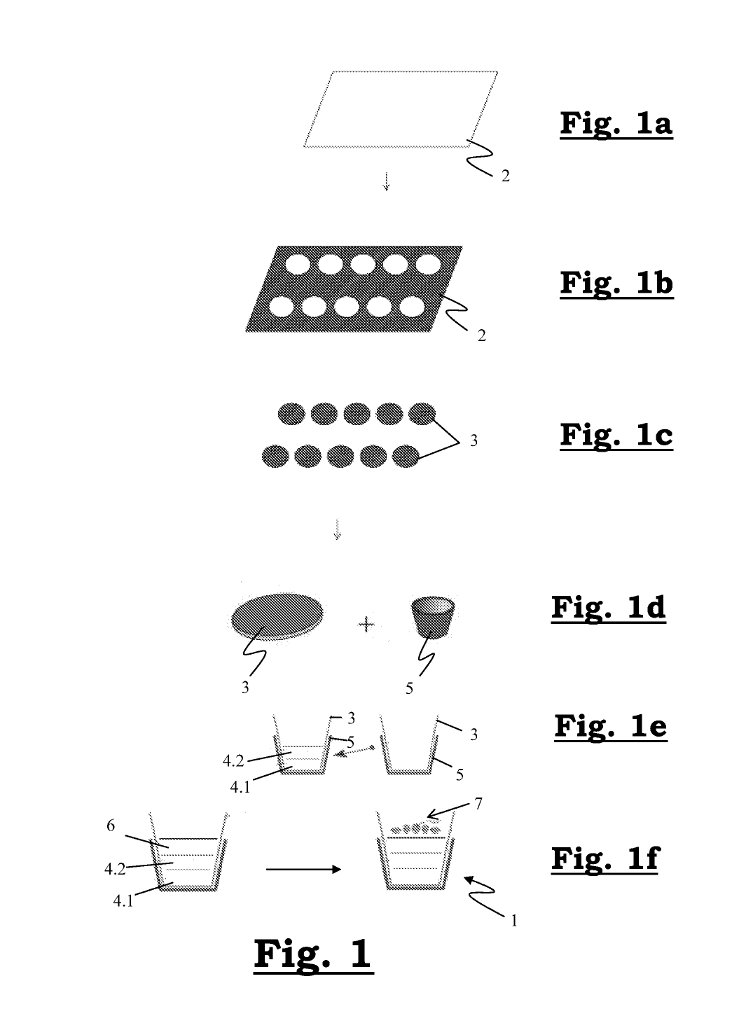

FIG. 1: shows, step by step, how a chocolate product in accordance with the method according to the invention is formed;

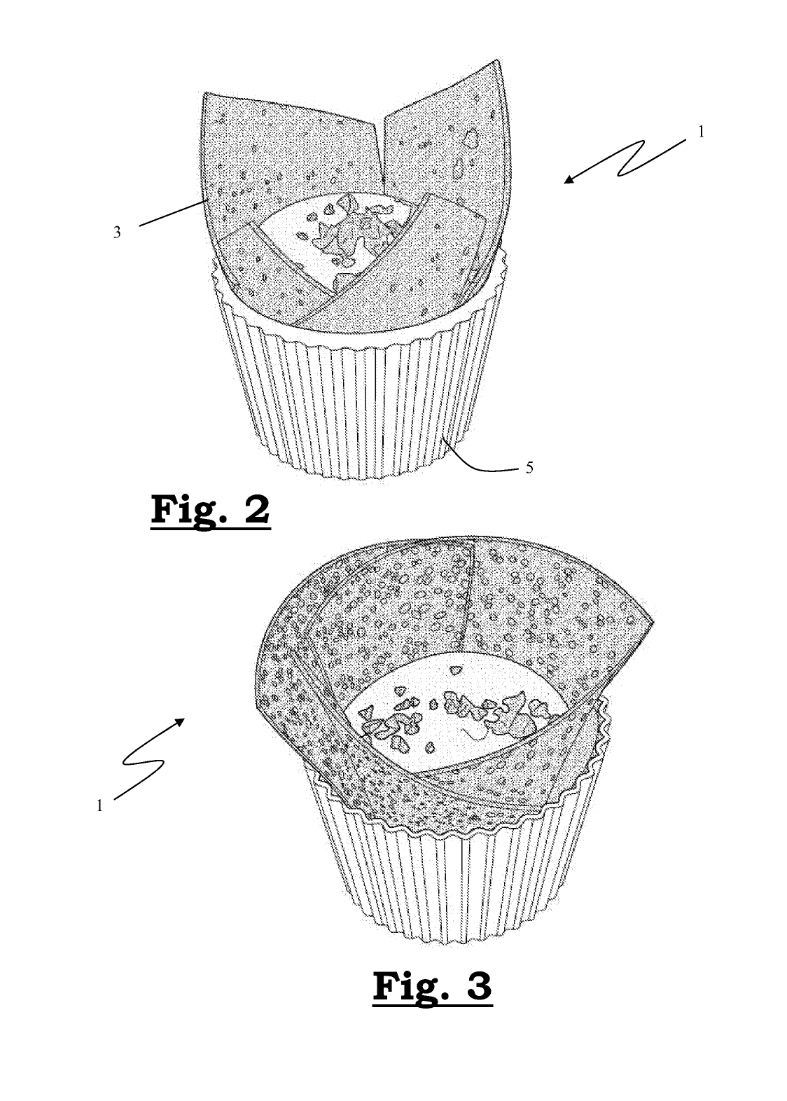

FIG. 2: shows a first embodiment of a chocolate product in accordance with the invention;

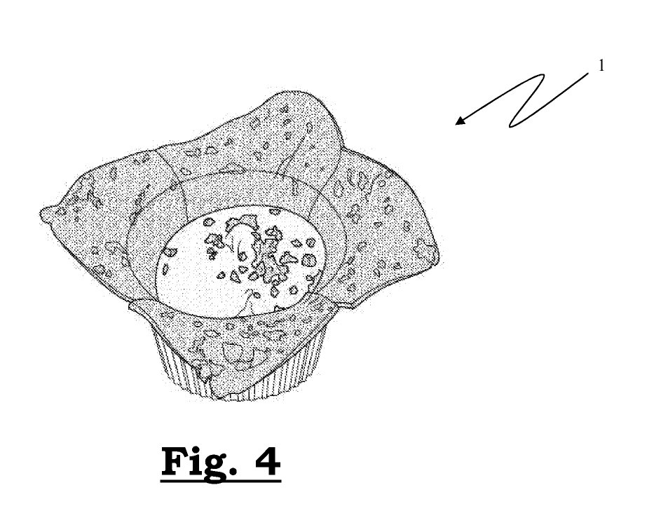

FIG. 3: shows a second embodiment of a chocolate product in accordance with the invention;

FIG. 4: shows a third embodiment of a chocolate product in accordance with the invention;

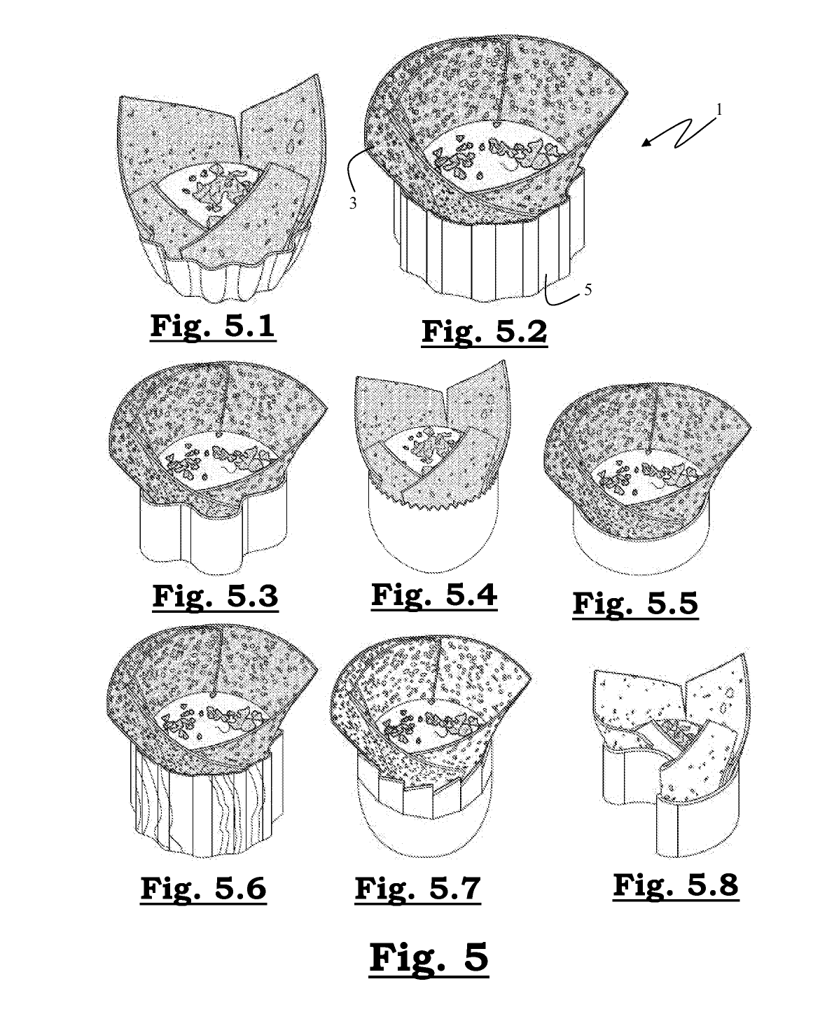

FIG. 5: shows a number of possible alternative embodiments of the formed chocolate product;

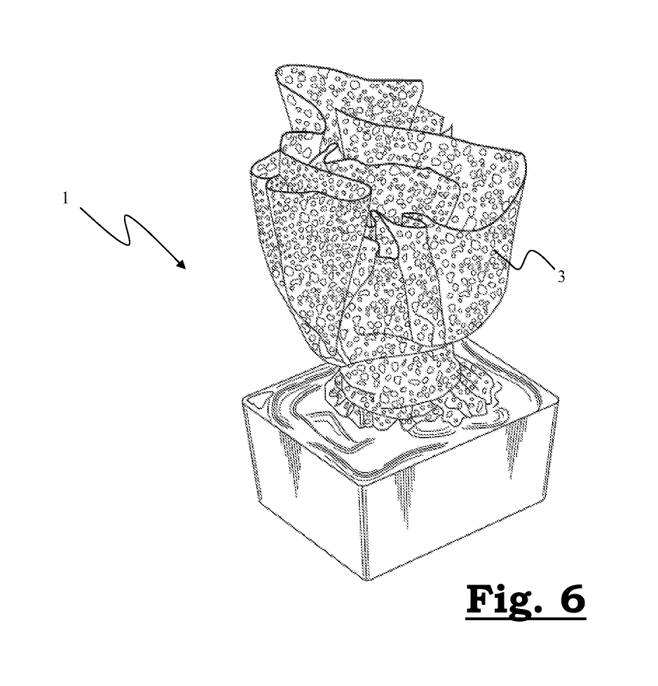

FIG. 6: shows a perspective representation of a chocolate product formed according to the alternative method, wherein the sheet is fully folded up, so that the applied filling is fully encased.

The present invention relates to a method for producing chocolate products (1), such as, for example, pralines, chocolates, etc. . . . , wherein the chocolate product (1) has a form relating at least partially to nature. The form can relate to flowers (as is shown in the appended figures), but it can also, of course, be other natural elements, such as, for example, plants, trees, stars, landscapes, . . . By relating the chocolate product (1) to nature, the product becomes more appealing to the consumer.

The method in accordance with the invention will be set out below, step by step, with reference to FIG. 1.

First of all, an elastic sheet (2) of edible material, such as, for example, a fruit film, is formed (FIG. 1a). The sheets have a thickness of between 0.5 and 2.5 mm and have as the basic ingredients fruits or fruit concentrates, a thickener and a softener, such as, for example, glycerol, fatty acids, and the like. As the thickener, gelatine, starch (possibly modified starch), agar-agar, pectin and gum is commonly used. Yet other ingredients can also be added in the preparation of the elastic sheet, especially single or multiple sugars, carbohydrates, fats, nut products (finely ground or not), assorted flavourings and colourings, and the like. In order to arrive at the sheet, the different basic ingredients are mixed together into a mixture and poured out into a layer. This can be done by pouring out the mixture onto a leaf or a sheet or something similar. This can also be realized industrially by pouring out onto a roll or a plate and afterwards immediately drying. The drying can be performed naturally or in an accelerated manner under the influence of ventilation and/or of heat. Following the drying, a sort of sheet is obtained, which can be used straightaway or it can be rolled up for subsequent further processing. The sheets can also be treated against drying-out or against degeneration. The treatment of the sheet against drying-out is generally realized by applying a thin layer of fat to the sheet. This prevents the migration of water, so that the drying-out is stopped. More particularly, the fat is cocoa butter, whether or not mixed with chocolate or other vegetable fats. Other products too can be used to prevent the sheet from drying out.

In accordance with the method according to the invention, a part (3) is punched out of the supplied sheet (2) of edible material (see FIGS. 1b and 1c). The punched-out part (3) is preferably a circle, but can also be an other geometric figure. The punched-out part (3) is placed in a holder (5) made of chocolate or another edible product (FIG. 1.d). This chocolate holder (5) can assume various forms, as can be seen, inter alia, from FIGS. 5.1 to 5.8. The most used forms are round (tubular or bowl-shaped), square, quadrangular and elliptical. It is evident, however, that forms deviating herefrom are likewise possible.

Once the punched-out part (3) is provided in the chocolate holder (5), a filling (4) is applied to the punched-out part (3), as is represented in Figure le. This filling (4) can be applied in one or more layers (4.1, 4.2). The applied filling (4) is preferably a mixture of different ingredients which are standardly used in the baking, patisserie and chocolate sector. These can be, for example, butter creams, liquid creams, praliné, ganaches, marzipan products, fruit fillings, caramel-based filling, truffle mixtures, or yoghurt fillings.

In order to cover the whole, as can be seen from FIG. 1f, a covering layer (6), preferably of chocolate or chocolate mixtures, can be applied, which covering layer can be provided with a decoration layer (7) and/or decoration element. Possible decoration layers and/or decoration elements are: chocolate products, sugar products, nuts, spices, edible plants or flowers, print designs (such as, for example, images, letters, logos) applied with edible ink, fruits or fruit products. The applied decoration layer and/or decoration elements can also be a mixture of different ingredients which, after mixing or preparation, can be applied to the covering layer.

In accordance with a preferred embodiment of the method according to the invention, and as represented in FIGS. 2 to 5, the punched-out part (3) provided with the filling (4) is folded such that at least a part of the applied filling (4) or, where appropriate, the covering layer (6), whether or not provided with a decoration layer and/or decoration element (7), remains visible. By giving the side edge of the punched-out part (3) a specific shape and/or making the incisions, a wide variety of chocolate products can be formed.

In an alternative embodiment of the method according to the invention, the punched-out part (3) provided with a filling (4) is fully folded up into parcels, wherein a sort of inclusion is formed of the filling in the sheet. As a result of the folding-up of the punched-out part provided with a filling, the side edge(s) of the punched-out shape will virtually butt one against another, whereby, as it were, stems or leaf-shaped element are formed. The effect can be reinforced by providing cut-outs in the side edge of the punched-out part (3). In order to avoid the possibility of the folded-up whole being opened out again, the sheet can be stuck tight with the aid of additives, such as, for example, starch solutions or something similar.

The finished chocolate product (1) has a unit weight of between 5 and 50 gram.

Following production, the chocolate product (1) is stored in an appropriate packaging. The packaging can be a standard packaging which is used in the chocolate industry, such as a ballotin, a flat box, a (completely or partially) transparent box, a metal box, etc. . . . The list of packagings is not exhaustive. The products can be stored under normal conditions or under conditioned atmosphere. By conditioned atmosphere is meant conditions which ensure that the product maintains its shelf life. Examples hereof are flowpack packagings with nitrogen atmosphere, with reduced oxygen atmosphere . . . Here too, the list is not exhaustive.

By now producing the chocolate products by means of the above-described method, a chocolate product which is provided with an element relating to nature is formed. The consumer of the chocolate product can hence clearly detect the link to nature. Moreover, by producing a chocolate product in such a way, it becomes possible to begin to combine different smells, tastes and/or colours in one and the same chocolate product.

1. Method for forming a chocolate product (1), characterized in that the method comprises the following steps:
the supply of a sheet of edible material (2);
the punching of a part (3) from the supplied sheet (2) of edible material;
the placement of the punched-out part (3) in a chocolate holder (5);
the application of one or more fillings (4) to the punched-out part (3) provided in the chocolate holder (5).

2. Method according to claim 1, wherein the punched-out part (3) provided with the filling (4) is folded such that at least a part of the applied filling (4) remains visible.

3. Method according to claim 1, wherein the punched-out part (3) provided with the filling (4) is folded up.

4. Method according to claim 1, wherein a covering layer (6) is applied to the one or more fillings (4).

5. Method according to claim 1, wherein the filling (4) or the covering layer (6) is provided with a decoration layer and/or decoration element (7).

6. Method according to claim 1, wherein the applied filling (4) is chosen from one or more of the following products: butter creams, liquid creams, praliné, ganaches, marzipan products, fruit fillings, caramel-based filling, truffle mixtures, and/or yoghurt fillings.

7. Method according to claim 1, wherein incisions are made in at least a part of the outer edge of the punched-out part (3).

8. Method according to claim 1, wherein the formed chocolate product (1) weighs between 5 and 50 gram.
